(19) United States
(12) Patent Application Publication
(10) Pub. No.: US 2007/0211578 A1
(43) Pub. Date: Sep. 13, 2007

(54) WATCH AND CLIP

(76) Inventor: Theresa Frank, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/681,656

(22) Filed: Mar. 2, 2007

Related U.S. Application Data
(60) Provisional application No. 60/782,258, filed on Mar. 13, 2006.

(51) Int. Cl. G04B 37/00

(52) U.S. Cl. 368/316

(57) ABSTRACT

A watch clip includes a back plate having front and back surfaces, and a spring body having first and second ends and an arched shape, the first end being coupled to the back surface of the back plate. The clip also includes a compression latch rotatably coupled to the second end of the spring body, and configured to apply a biasing force to an object such as the panel of a pocket interposed between a portion of the spring body and the back surface of the back plate. The compression latch is configured to rotate between open and latched positions. While in the open position, the device is configured to receive the pocket panel between the back plate and the portion of the spring body, and to capture the panel between a contact bar and the back plate while in the latched position. A timepiece is coupled to the front surface of the back plate.

### BACKGROUND OF THE INVENTION

1. Field of the Invention

This disclosure is related, generally, to timepieces, and in particular, to fashion watches.

2. Description of the Related Art

For many women, typical party or formal attire comprises a dress or evening gown designed to show or suggest a great deal of the woman's body. These dresses may be form fitting, low-cut, or otherwise quite revealing. This is especially true in what is often thought of as high fashion, as is evident from a review of any fashion or awards show broadcast by the major television networks. These fashions are also followed among the less famous, but still affluent, women of most major cities in the world.

While many women wear wrist watches while in formal attire, and many jewelers offer watches designed for this purpose, other women prefer not to wear a wrist watch with an evening gown. This presents a problem, since these gowns certainly don't include pockets where a watch can be kept. The only other alternative, if one wishes to have a timepiece, is to keep a watch in a purse. Of course, this means that checking the time will be something of a production, as the purse will also contain everything the woman might need for the evening, materials for maintenance of hair and makeup, money, cell phone, keys, etc., much of which may need to be removed to locate the watch.

### BRIEF SUMMARY OF THE INVENTION

According to an embodiment of the invention, a watch is provided, including a back plate having front and back surfaces, and a spring body having first and second ends and an arched shape, the first end being coupled to the back surface of the back plate. The device also includes a compression latch rotatably coupled to the second end of the spring body, and configured to apply a biasing force to an object such as the panel of a pocket interposed between a portion of the spring body and the back surface of the back plate. The compression latch is configured to rotate between open and latched positions. While in the open position, the device is configured to receive the pocket panel between the back plate and the portion of the spring body, and to capture the panel between a contact bar and the back plate while in the latched position. A timepiece is coupled to the front surface of the back plate.

### BRIEF DESCRIPTION OF THE SEVERAL VIEWS OF THE DRAWING(S)

FIG. 1 shows a woman in evening dress carrying a watch clipped to a panel of her handbag, according to an embodiment of the invention.

FIG. 2 illustrates the watch of FIG. 1, in a rear perspective view.

FIG. 3 is a side elevation view of the watch of FIG. 1.

FIG. 4 shows a front elevation view of the watch of FIG. 1.

FIGS. 5A and 5B illustrate steps of the operation of the watch of FIG. 1.

FIG. 6 shows a watch according to another embodiment of the invention.

FIG. 7 shows a back view of the watch of FIG. 6.

FIGS. 8 and 9 show side elevation views of the watch of FIG. 6.

FIG. 10 illustrates additional embodiments of the invention.

### DETAILED DESCRIPTION OF THE INVENTION

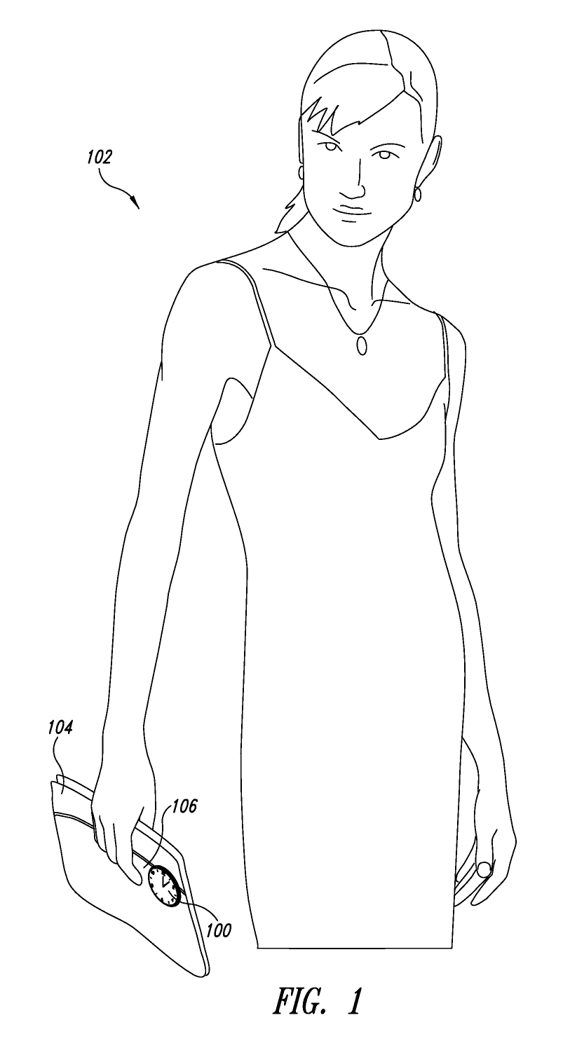

FIG. 1 shows a woman 102 dressed for a formal outing and carrying a small clutch bag 104 for essential supplies. Attached to a pocket 106 of the bag is a watch 100 according to an embodiment of the invention. The watch 100 includes a clip configured to attach to a pocket panel 106 of the handbag 104 in a manner that is secure, yet will not damage expensive fabric or leather from which the bag is made.

Carrying a watch in this manner allows the woman to check the time unobtrusively, and without fanfare. Additionally, the watch 100 may be of a design that compliments her outfit or accessories, and provides a unique fashion statement. She also has the option of attaching the watch 100 to an interior pocket of the handbag 104, where it is instantly accessible, while remaining invisible. She no longer needs to dig through the contents of the bag to find her watch, but instead, can merely open the bag and look inside to check the time, without extracting the watch 100 or any other contents.

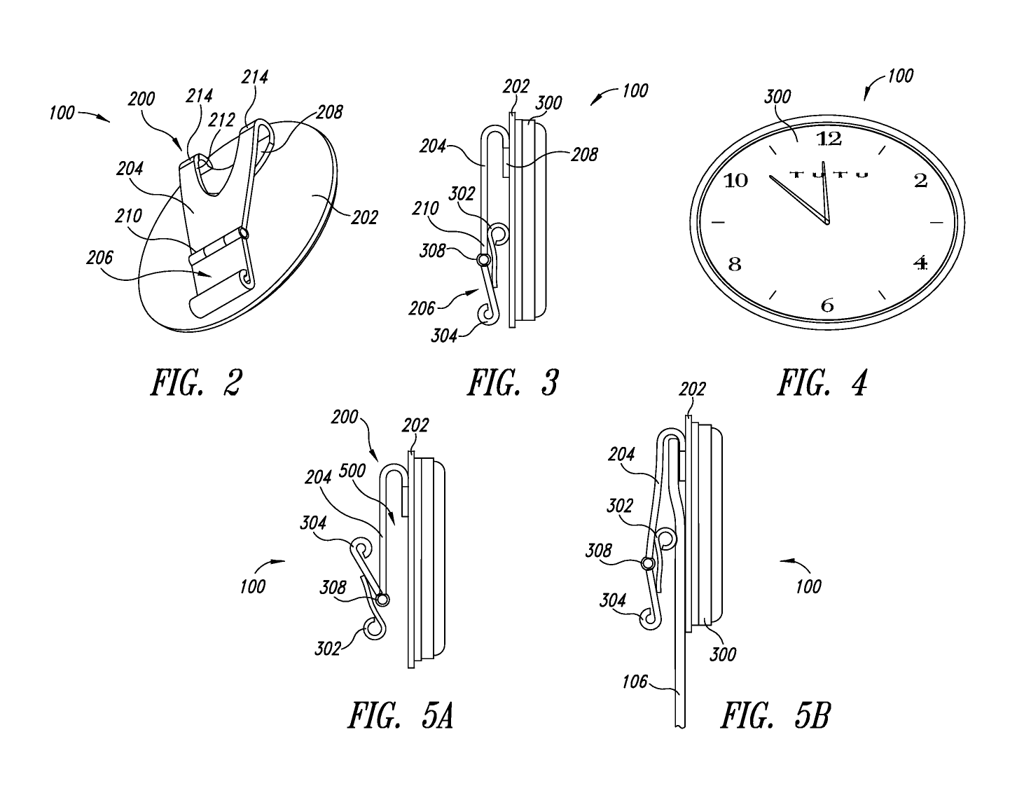

Referring now to FIG. 2, the watch 100 is shown in a rear perspective view. A clip assembly 200 is provided for attaching the watch 100 to the woman's purse 104. The watch 100 includes a back plate 202, to which the clip assembly 200 is attached. The clip assembly comprises a spring body 204 and a compression latch 206. The spring body 204 is attached at a first end 208 to the back plate 202 by any appropriate means, such as, for example, screws, rivets, spot welds, etc. The compression latch is hinged to a second end 210 of the spring body 204 so as to be rotatable around an axis that lies parallel to a surface of the back plate 202.

FIG. 3 is a side view of the watch 100, showing additional details of the clip assembly 200. The spring body 204 is attached at its first end 208 to the back plate 202, and includes an arched portion 306 such that the second end 210 of the spring body 204 is separated from the back plate 202 by a space appropriate to receive a pocket panel or other substantially flat or thin object as described hereafter. The compression latch 206 includes a contact bar 302 and a finger bar 304. In the embodiment of FIG. 3 the contact bar 302 is attached to the compression latch, such as by welding or soldering, or other appropriate method. The latch 206 is coupled to the spring body via a hinge 308. A time piece 300 is mounted to a front face of the back plate 202. The time piece 300 may be digital or analog, and may include design features such a jeweled or mother-of-pearl face.

Referring again to FIG. 2, the spring body 204 includes an aperture 212 that coincides with the arched portion 306 such that the spring body 204 has two narrow arms 214 that define the arched portion 306. This arrangement provides several advantages. As will be discussed in more detail below, the spring body 204 flexes during operation. By selecting the width of the narrow arms 214, the tension and resiliency of the spring body 204 can be selected, so as to provide a desired level of bias. Additionally, the narrow arms 214 afford a convenient location to attach embellishing features or decorations to the watch, as will also be described in more detail hereafter.

It can be seen that the clip assembly 200 is sized or positioned on the watch so as to be substantially invisible when the watch 100 is viewed from the front. This prevents the clip from interfering with the aesthetic appearance of the watch, providing for a clean, uncluttered face. In particular, the spring body 204 is positioned such that it does not extend above the upper edge of the watch 100. According to an embodiment, the back plate 202 may be larger than the watch 100, as shown, for example, in FIG. 3, so as to contribute to the decorative appearance. According to other embodiments, the back plate 202 may be of equal or smaller size than the watch, or the back plate may be part of the watch case, as shown, for example, in FIG. 7.

The timepiece 300, as illustrated in FIG. 4, has an analog face with an oval shape. It will be recognized that the timepiece may have any appropriate shape such as, for example, oval, round, square, rectangular, etc. Additionally, the clock face of the timepiece is not limited as to other design features such as color, style, or presence or absence of numbers, etc.

Referring now to FIGS. 5A and 5B, the operation of the clip mechanism 200 is illustrated. In FIG. 3, the latch 206 is shown in the latched position. From this position, a user places a finger under the finger bar 304 and pries the finger bar 304 outward with respect to the back plate 202. The compression latch 206 rotates on the hinge 308, causing the contact bar 302 to lever against the back plate 202 with the hinge 308 as a fulcrum. The spring body 204 is forced to flex outward and permit rotation of the compression latch 206 to an open position.

FIG. 5A shows the latch mechanism 200 in the open position. In this position, a slot 500 is open. the user can now slide the watch 100 over a handbag pocket such that the panel 106 of the pocket is received in the slot 500 until the top edge of the panel 106 contacts the inner surface of the spring body 204, as shown in FIG. 5B. The user then pulls downward on the finger bar 304, reversing the rotation of the compression latch 206. The contact bar 302 again levers on the hinge 308 to force the spring body 204 to flex outward, while the contact bar 302 moves inward. FIG. 5B shows the latch 206 again in the latched position, but with the panel 106 captured by the contact bar 308. It may be seen that, due to the thickness of the panel 106, the spring body 204 is flexed outward, applying a bias against the panel 106 via the contact bar 302, providing sufficient force against the panel to securely hold the watch 100 to the panel 106. However, because of the smooth shape of the contact bar 302, and especially because of the smooth, flat surface of the back plate 202, against which the panel 106 is pressed by the contact bar, the panel is not damaged or marked by the clip assembly 200.

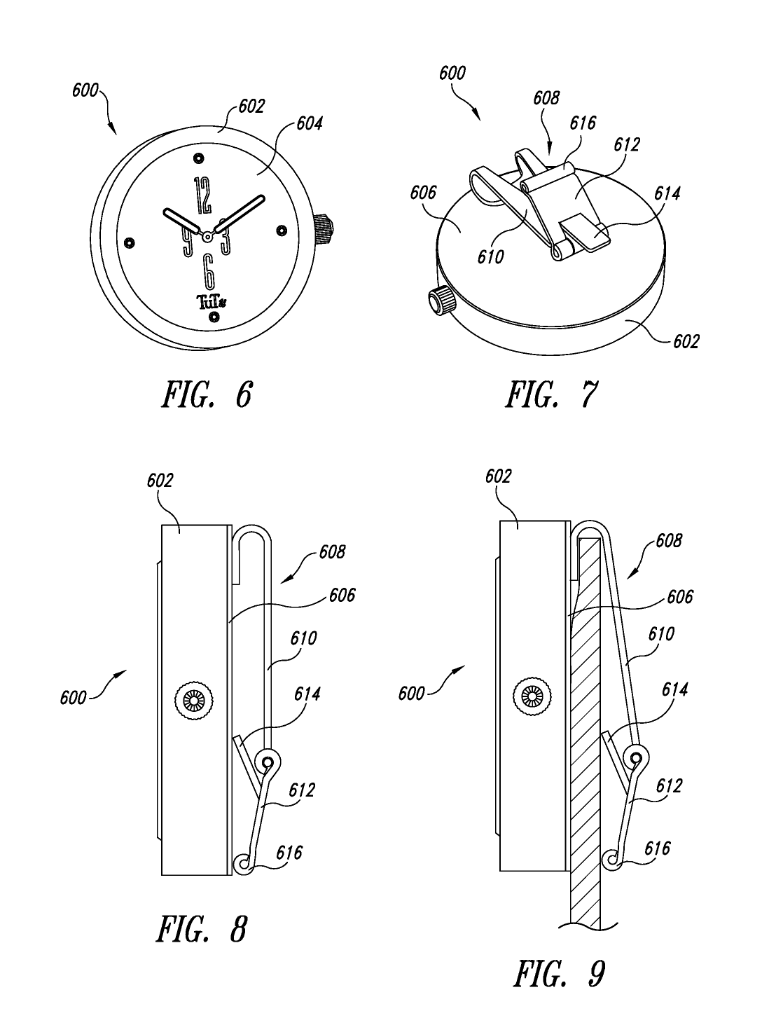

FIGS. 6-9 show a watch 600 according to another embodiment of the invention. A case 602 of the watch 600 includes a face 604 and back plate 606. A clip assembly 608, including a spring body 610 and compression latch 612, is attached to the back plate 606. The compression latch 612 includes a contact bar 614 and finger bar 616 formed from a single piece of material, as can be seen in FIG. 7. This arrangement reduces the manufacturing cost as compared to the embodiment of FIG. 3. Another feature of this embodiment is that when the compression latch 612 is in the latched position, as shown in FIG. 9, both the contact bar 614 and finger bar 616 make contact with the object 106 to which the watch 600 is attached. This provides an increased surface area of contact with the object 106, resulting in a more secure attachment.

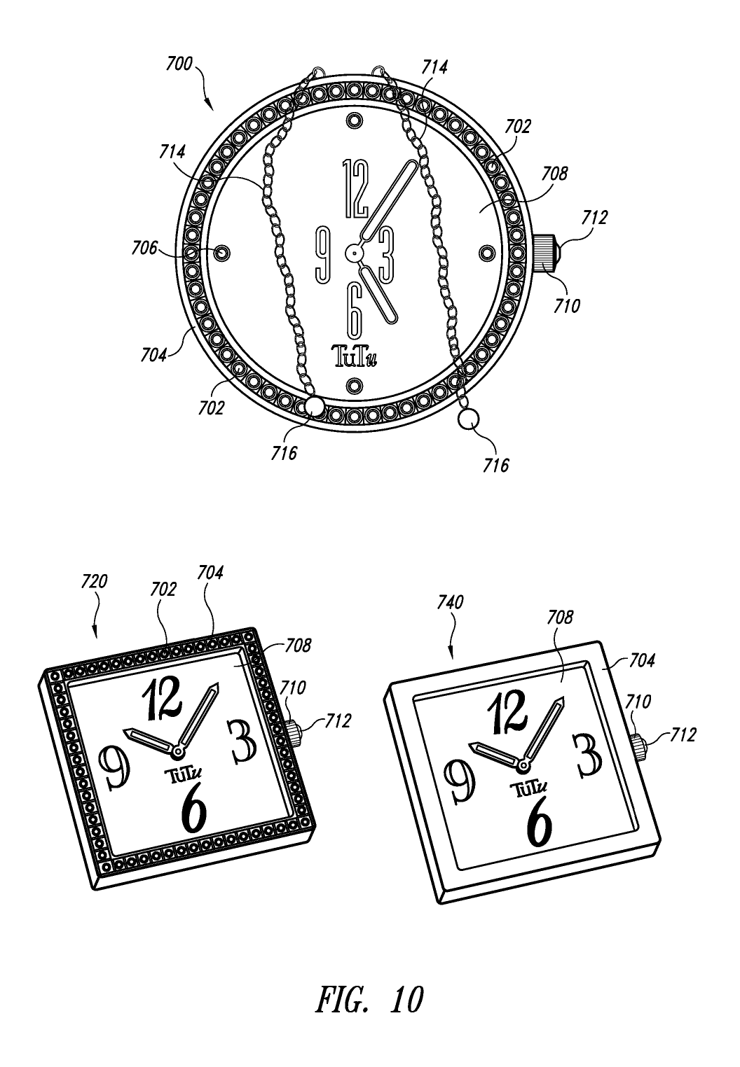

FIG. 10 shows watch faces according to various additional embodiments of the invention. The watches 700, 720, and 740 of FIG. 10 are provided with various embellishments and details. For example, some include a number of stones 702 distributed around the bezel 704, as well as stones 706 on the face 708. Additionally, the crowns 710 may be provided with a single stone 712. The stones may be cubic zirconium crystals, Swarovski® crystals, diamonds, or other precious, semi-precious, or synthetic stones, and may be clear or colored. The face 708 may be mother of pearl, enamel, or other known material, and may include luminous hands or accents for easier vieweing under low-light conditions. The case 602 may be gold or gold plate, stainless steel, platinum, or other appropriate material. The watch 700 is provided with an accent detail in the form of small chains 714 attached to respective ones of the narrow arms 214 described with reference to FIG. 2, each of the chains 714 having a small pearl 716 attached. According to another embodiment, the chains 714 are provided with clasps, and are of a length sufficient to form a necklace with the watch 700 as a pendant.

It will be recognized that a watch according to the principles of the invention provides the convenience of easy access to a timepiece while enhancing the formal or festive appearance of the wearer. According to some embodiments the watch is configured to be eye-catching and compelling, while in other embodiments, the watch is configured to be more subtle and understated.

There are some watches in the known art that are configured to be attached or hung in various manners. For example, one type of watch, used primarily in the middle part of the 20th century, was configured to be worn on an apron or blouse by a nurse. However, this watch was typically pinned to the nurse's blouse, and thus would be inappropriate for the present application, since a pin would tend to damage the expensive material of a fashion handbag. Other known watches are configured to hang from a user's belt. These, too, are unsuitable for the present application, since they generally include a loop through which the belt passes. The panel of a handbag pocket is generally open only at the top, would not allow passage of a loop, and so would not accept such a mechanism.

In contrast to the prior art examples mentioned above, embodiments of the present invention provide means for non-invasively securing a watch to a panel of a pocket or similar feature in a way that allows the watch to be easily viewed without the securing means distracting from the decorative aspects of the watch or damaging the object to which the watch is attached.

As used in the claims, the term non-invasive refers to the characteristic of attaching without causing damage such as would be caused by a pin, for example.

Where the term upper edge is used with reference to a watch, it refers to a watch oriented according to convention, i.e., in the case of an analog watch, the clock face is arranged so that when the hands indicate 12:00, they are pointing straight up, and, in the case of a digital watch, the clock face is arranged so that the numbers are upright.

Embodiments of the invention have been described for use with the pocket of a handbag. It will be recognized that a watch according to the principles of the invention may be attached to any appropriate object, such as, for example, a user's belt, coat or pants pocket, book cover, note pad, or even rigid objects such as the rim of a vase, etc. The only requirement is that the object have a portion that is sufficiently thin to be received by the clip assembly. Accordingly, where used in the claims, the term flat object is to be read broadly so as to encompass all such objects.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device comprising:
a watch case
a back plate attached to a back side of the watch case;
a watch positioned within the watch case;
a watch face visible from a front side of the watch case;
a spring body having first and second ends, the first end being coupled to the back plate on a side of the back plate opposite the watch; and
a compression latch rotatably coupled to a second end of the spring body, and configured to apply a biasing force to the back plate.

2. The device of claim 1 wherein the compression latch is rotatable between a latched and an open position, and wherein, when the compression latch is in the open position, it extends away from the back plate such that a space between the second end of the spring body and the back plate is unobstructed, and when the compression latch is in the latched position, it applies the biasing force to the back plate so as to grip an object interposed between a portion of the spring body and the back plate.

3. The device of claim 1 wherein the spring body and compression latch are sized, relative to the watch case, such that no portion of the spring body or compression latch extends beyond a circumference of the watch case.

4. The device of claim 1 wherein the compression latch includes a finger bar configured to provide purchase for a user's finger for rotating the latch, and a contact bar configured to transmit bias from the spring body to the back plate.

5. The device of claim 4 wherein the compression latch is configured to rotate between open and latched positions, and wherein, while in the open position, the device is configured to receive the object between the back plate and the second end of the spring body, and to capture an object between the contact bar and the back plate.

6. The device of claim 1 wherein the spring body comprises an arched portion defining a space between the second end of the spring body and the back plate of the case.

7. The device of claim 1 wherein the spring body comprises an aperture such that a portion of the spring body includes two narrow arms extending on opposite sides of the aperture.

8. The device of claim 7, comprising one or more decorative chains coupled at first ends to one or both of the two narrow arms so as to dangle below the watch case.

9. A watch comprising:
a watch case;
a clock face visually accessible from a first side of the watch case; and
a clip assembly coupled to a second side of the watch case and configured to non-invasively attach the watch to a flat object, the clip assembly being sized, relative to the watch case, so as to be substantially not visible when viewed from a direction normal to the first side of the watch case.

10. The watch of claim 9 wherein the clip assembly comprises a spring body coupled to the watch case at a first end thereof, and a compression latch coupled to a second end of the spring body.

11. The watch of claim 7 wherein the compression latch is rotatable, with respect to the spring body, between a latched position and an open position, the compression latch being configured such that, while in the latched position, the compression latch, biased by the spring body, bears against the second side of the watch case, and while in the open position, the compression latch extends away from the second side of the watch case leaving an unobstructed space between the second end of the spring body and the second side of the watch case.

12. A device comprising:
a handbag having a pocket on an outer portion thereof;
a watch having a non-invasive clip coupled to the pocket of the handbag so as to be visible on an outer surface thereof, the clip being positioned on the watch so as to extend no higher than an upper edge of the watch.

13. The device of claim 12 wherein the clip includes a spring body coupled at a first end to a back side of the watch and having an arched portion so as to define a space into which a panel of the pocket is positioned.

14. The device of claim 12 wherein the clip includes a compression latch configured to apply a compressing bias to the pocket.

15. The device of claim 12 wherein the clip includes a spring body coupled at a first end to a back side of the watch and a compression latch rotatably coupled to a second end of the spring body so as to transmit a compressing bias from the spring body to the pocket.
